(19) United States
(12) Patent Application Publication
(10) Pub. No.: US 2026/0324598 A1
(43) Pub. Date: Oct. 22, 2026

(54) ADAPTABLE DOG LEASH AND COLLAR SYSTEM FOR ENHANCED SOCIALIZATION AND TRAINING

(71) Applicants: Christopher Wojda, Lake Oswego, OR (US); Kevin Lozeau, Charlotte, NC (US); Adriana Kliegman, New York, NY (US); Arsenio García Monsalve, Brooklyn, NY (US)

(72) Inventors: Christopher Wojda, Lake Oswego, OR (US); Kevin Lozeau, Charlotte, NC (US); Adriana Kliegman, New York, NY (US); Arsenio García Monsalve, Brooklyn, NY (US)

(21) Appl. No.: 19/534,310

(22) Filed: Feb. 9, 2026

Related U.S. Application Data
(60) Provisional application No. 63/760,594, filed on Feb. 19, 2025.

(51) Int. Cl. A01K 27/00; A01K 25/00

(52) U.S. Cl. CPC A01K 27/003; A01K 27/002; A01K 27/005

(57) ABSTRACT

An animal control system is provided that includes: an elongated strap having a first end and a second end; a first gate clip coupled to the first end of the elongated strap and a second gate clip coupled to the second end; and a selectively engageable guide loop positioned proximate to the first end of the elongated strap. The guide loop includes a segment of the elongated strap folded upon itself and secured by a first fastener and a second fastener, where the first fastener creates a first loop for attaching the first gate clip to the first end and the second fastener creates the guide loop adjacent to the first loop, the leash therewith configured for use selectively as at least a slip leash and a harness.

### CROSS REFERENCES TO PRIORITY APPLICATIONS

The present application claims priority to U.S. Provisional Patent Application No. 63/760,594, entitled “Modular Dog Leash and Collar System for Enhanced Socialization and Training,” filed Feb. 19, 2025, which is hereby incorporated by reference in its entirety.

### BACKGROUND

The present application relates generally to animal control systems and, more specifically, to modular leash and collar systems configured for canine management and behavioral training.

Conventional dog handling tools fall into two categories: management tools and dynamic training tools. Management tools, such as no-pull harnesses and head-halters, are designed to provide immediate physical redirection. However, these tools often lack the nuanced tactile feedback necessary for long-term behavioral reinforcement, frequently leading to a perpetual reliance on the device rather than successful training. Conversely, dynamic training tools—including prong or electronic collars—utilize pressure to discourage undesirable behaviors. While effective when used by experts, these tools often require a high degree of technical skill and timing to ensure efficacy and animal welfare. Improper application can result in inconsistent results or negative behavioral side effects.

Although management tools can be fast and easy for the handler to get their dog to stop pulling on the leash, they are often uncomfortable for the dog, unattractive, and detrimental to training because they don't provide appropriate feedback to help the dog advance and for the tool to be retired. The problem with most dynamic training tools, such as prong collars and electronic collars, is that they require patience, skill, and knowledge from the dog's handler to be fair and effective. Training programs that use these tools can get results reliably, but if not done correctly, to the detriment of the dog's well-being and its relationship with people. Dynamic tools, despite their flaws, are necessary since standard flat collars and harnesses promote pulling by engaging the dog's opposition reflex (the reflex all dogs have that causes dogs to pull on the leash).

Finding the best solution for each person and dog often takes several purchases with trial and error to find a workable solution. Often, dogs end up wearing two or three different collars depending on what the handler has planned for the dog. This lack of a unified, adaptable system leads to mechanical inconsistency, aesthetic mismatch, and unnecessary consumer expense, in addition to the other problems noted above. Accordingly, there is a need for a versatile animal control system that provides intuitive feedback for training while remaining comfortable and adaptable for various handling scenarios.

### SUMMARY OF THE INVENTION

The present application provides a single leash (with or without a collar) system that provides options for the socialization and training of dogs and other animals using industry standard Least Intrusive Minimally Aversive (LIMA) training techniques. This ensures each handler has the tools to humanely and successfully manage or train their dog when in public, in a package that is designed to work together, look good together, and to signal to others using the same system that you're open to “saying hi” for socialization opportunities. This allows dog owners to go from managing a completely untrained dog to loose-leash walking a trained dog using the same leash and collar with features that make controlling unruly dogs easy.

In one aspect, an animal control system is provided that includes: an elongated strap having a first end and a second end; a first gate clip coupled to the first end of the elongated strap and a second gate clip coupled to the second end; and a selectively engageable guide loop positioned proximate to the first end of the elongated strap. The guide loop includes a segment of the elongated strap folded upon itself and secured by a first fastener and a second fastener, where the first fastener creates a first loop for attaching the first gate clip to the first end and the second fastener creates the guide loop adjacent to the first loop, the leash therewith configured for use selectively as at least a slip leash and a harness.

In one embodiment, the second fastener includes a snap assembly including a male component and a female component integrated into the elongated strap detachable from each other to provide an opening for routing the second end of the leash through the guide loop.

In one embodiment, the first and second fasteners are spaced apart by a distance of about 2 to about 4 inches.

In one embodiment, the animal control system includes at least one integrated slide moveably disposed along the elongated strap between the first end and the second end, the integrated slide including a grommet configured to receive one of the first or second gate clips.

In one embodiment, the at least one integrated slide is configured to act as a mechanical stop to regulate the diameter of a loop formed by the elongated strap when the lead is configured as a slip lead or a thorax-wrap harness.

In one embodiment, the elongated strap comprises a material selected from the group consisting of Biothane, nylon, polypropylene, and leather.

In one embodiment, the system includes a collar, the collar including: a strap body and a buckle for securing the collar around an animal's neck; a safety O-ring configured for attachment to at least the first gate clip; and a first pair of symmetrically positioned D-rings maintained in a fixed position relative to the safety O-ring.

In one embodiment, the collar further comprises a second pair of symmetrically positioned rings maintained in a fixed position relative to the safety O-ring.

In one embodiment, the system includes a removable head halter assembly, the head halter assembly including: a nose strap portion; a pair of rings configured to couple the nose strap to the first connector of the lead; and a cross-junction member configured to position segments of the nose strap at approximately 90 degrees to each other while allowing each segment to slide independently through the cross-junction member; the collar further configured for the head halter assembly to attach to the first and second pairs of symmetrically spaced rings.

In another aspect, an animal control method is provided that includes selectively configuring an animal control system between a slip leash function and a harness function, the system including any of the aforementioned elements.

In another aspect, an animal control system is provided that includes an elongated strap having a first end and a second end, the first end configured to selectively attach to an animal in a plurality of ways and the second end configured to selectively attach to the handler in another plurality of ways.

In one embodiment, the elongated strap includes a first gate clip coupled to the first end of the elongated strap and the second a second gate clip coupled to the second end; and a selectively engageable guide loop positioned proximate to the first end of the elongated strap, that allows the system to be selectively attached to the animal as at least a slip leash and a harness.

### BRIEF DESCRIPTION OF THE DRAWINGS

FIG. 1 is a top perspective view of the animal control system according to a preferred embodiment in a first configuration, illustrating a leash 100 attached to a flat collar 200 at a single point for standard walking.

FIG. 2 is a top perspective view of the preferred system in a second configuration, illustrating the leash 100 attached to the dog's neck via integrated slip lead functionality with an integrated slide 102 positioned to create a mechanical stop.

FIG. 3a is a top perspective view of the preferred system in a third configuration, illustrating the leash 100 attached to a flat collar and wrapped around the thorax of the dog using the proprietary guide-loop 105 to discourage pulling.

FIG. 3b is an enlarged perspective view of the connection mechanism for the harness configuration, specifically detailing the guide-loop 105 and the snap 106 used for securing the thorax wrap.

FIG. 4a is a perspective view of the preferred system in a fourth configuration, illustrating leash 100 attached to a removable head halter 300 assembly for advanced directional control.

FIG. 4b is a bottom perspective view of the head halter assembly of the preferred system, specifically detailing the halter-cross 303 positioned under the dog's chin to guide the nose strap 302.

FIG. 5 is a side perspective view of the preferred system in a fifth configuration, illustrating a dual attachment point where leash 100 is wrapped around the thorax and attached at the top of the collar's O-ring 203 which can effectively reduce the length of the leash by half.

FIG. 6 is a top perspective view of the of the preferred system in a sixth configuration, illustrating a dual attachment utilizing integrated slip lead functionality and a connection to flat collar 200.

FIG. 7 is a top perspective view of the preferred system in a seventh configuration, illustrating the leash 100 attached via integrated slip lead functionality, a flat collar connection, and a thorax wrap.

FIG. 8a and FIG. 8b are perspective views from different angles illustrating the leash 100 attached to the flat collar 200, wrapped around the thorax, and additionally attached to the removable head halter 300.

FIG. 9 is a perspective view of the preferred system illustrating the leash 100 attached via integrated slip lead functionality and further coupled to the removable head halter 300.

FIGS. 10A-1, 10A-2, 10B, 10C, and 10d are perspective views of the preferred system illustrating the various handler attachment and tethering options, including a wrist loop, an adjustable waist loop, an adjustable shoulder loop, and a fixed object tether, respectively.

FIG. 11 is a perspective view of an alternative embodiment of the animal control system utilizing a round leash construction.

FIG. 12 is a view of a slide 102 according to a preferred embodiment.

FIG. 13 is a perspective view of an alternative embodiment of the animal control system utilizing a round leash construction and two types of sliders 102.

### DESCRIPTION

An animal control system is provided that can be used in a plurality of configurations, including as a leash with any dog collar (fixed-diameter or otherwise), as a slip lead, and/or as a harness, or any combination thereof.

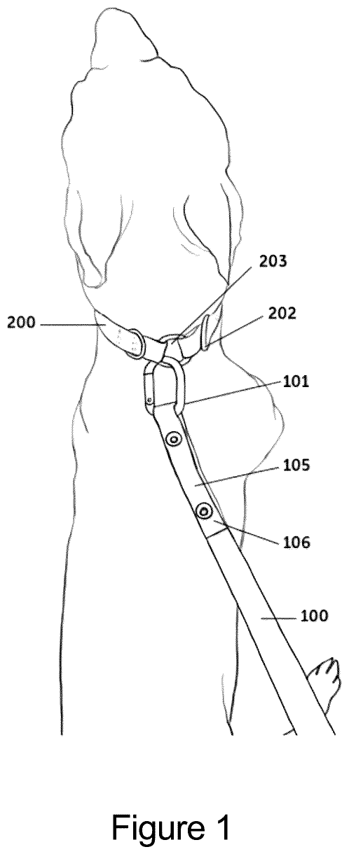

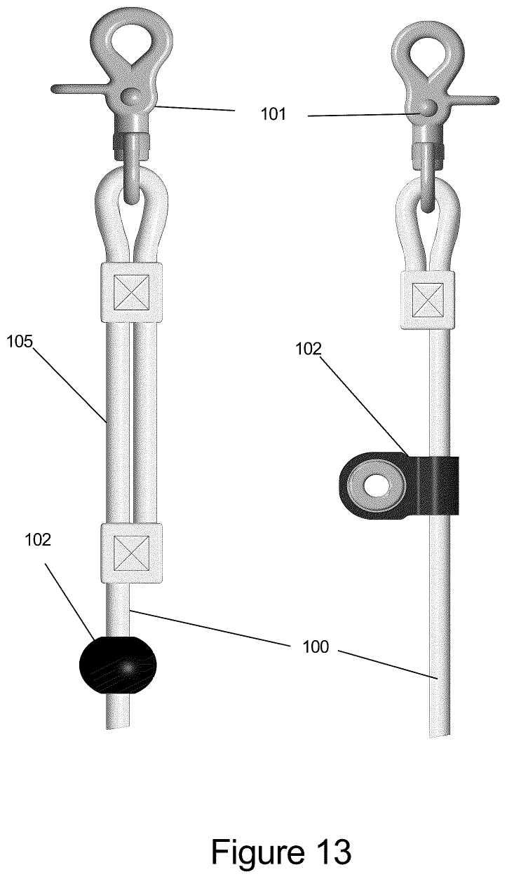

Components of the leash 100, according to a preferred embodiment, may include: a) Gate clips 101 on both ends of leash 100 to provide single or double connections to the dog and allow the leash to slide through easily to create a slip lead function; b. Two integrated slides 102 with grommets 103 for custom leash lengths and attachment points (wrist, shoulder, waist, and tether options), as shown in FIGS. 10A-1 to 10C, or integrated slides 102 without grommets, such as cord locks, or any combination thereof, as shown in FIG. 13. The slides 102 can also function as stops when the leash is used as a slip lead or chest (thorax) harness; c. Integrated fixed grommets 104 for common fixed attachment points (wrist) and to hold poop bags; d. A “guide-loop” 105 that can optionally be detached from itself with a feature such as a snap 106 for guiding and securing the leash when used to wrap around a dog's thorax. The guide-loop 105 can also be used to attach a poop bag dispenser; e. The leash can be flat, or round. Flat leashes can be 7/16″ to 1″ wide while the round leashes can be between 6 mm to 12 mm thick. The leash can be 4′ to 12′ long. Both types of leashes can be made from Biothane, Nylon, Polypropylene, Leather and other materials typical for leashes.

Components of the collar 200 and head halter 300, according to the preferred embodiment, may include: a. standard buckle 201 for security; b. Proprietary symmetrically positioned D-rings (qty 4) 202 for securing the head halter strap and tags to the collar. The D-rings remain in a fixed position relative to the buckle and the safety O-ring 203 regardless of the buckle adjustment position; c. O-ring 203 for double leash attachments and safety collar functionality; d. Two small D-rings 301 for attaching the head halter 300 to the leash: e. Nose strap 302 for head halter functionality may be made of a narrow flat strap; f. Proprietary “halter-cross” 303 for guiding the head halter and securing it on the dog. The cross positions the nose strap segments at 90 degrees to each other and allow each segment to slide independently of each other. This component can be made of plastic or metal; g. The collar may be made of a wide flat strap such as Biothane, Nylon, Polypropylene, Leather and other materials typical for collars. The leash 100 may be used with any conventional collar, including single D-ring designs with fixed buckles, etc.

The system provides options for the socialization and training of dogs using industry standard Least Intrusive Minimally Aversive (LIMA) training techniques. This ensures each person always has the tools to humanely and successfully manage or train their dog when in public. The system is designed to work together, look good together, and to signal to others that you are open to “saying hi” for socialization opportunities. This allows dog owners to go from managing a completely untrained dog to loose-leash walking a trained dog using the same leash and collar.

Key features of leash and collar system include that it has a modular and/or adaptable design preferably configured to connect to the dog in the following ways:
a. A leash attached to the dog at a single point on the dog's collar.
b. A leash attached to the dog at a single point via integrated slip lead functionality.
c. A leash attached to the dog at a D-ring or O-ring on the dog's collar and wrapped around the dog's thorax to discourage pulling.
d. A leash attached to the dog at the point where the optional head halter comes together.
e. A Jaeger-style leash to attach to the dog at any two points previously described.

The leash is preferably designed to connect to people or objects in the following ways:
a. A leash that the person can control with a wrist loop.
b. A leash that the person can control with an adjustable shoulder loop.
c. A leash that the person can control with an adjustable waist loop.
d. A leash that the person can attach to a fixed object for tethering.

FIG. 1 illustrates a top perspective view of the animal control system in a first configuration, with the leash 100 attached to a flat collar 200 generally for a dog that does not pull. The leash 100 is detachably coupled to a collar 200 as worn by a canine subject. The leash 100 is depicted as a flat strap, which may vary in width from approximately 7/16″ to 1″, though it is understood that a strap with a round cross-section may also be utilized. The collar 200 is secured around the neck of the dog and includes a plurality of symmetrically positioned D-rings 202 relative to O-ring 203. As shown, these D-rings 202 are distributed along the circumference of the collar 200 and remain in a fixed, equal-distant position relative to the safety O-ring 203. This fixed symmetry ensures that attachment points for a head halter (not shown) or identification tags remain accessible regardless of how the collar is adjusted via the standard buckle (not shown). The buckle/clasp (not shown) for opening collar 200 may be on the opposite end from the O-ring 203.

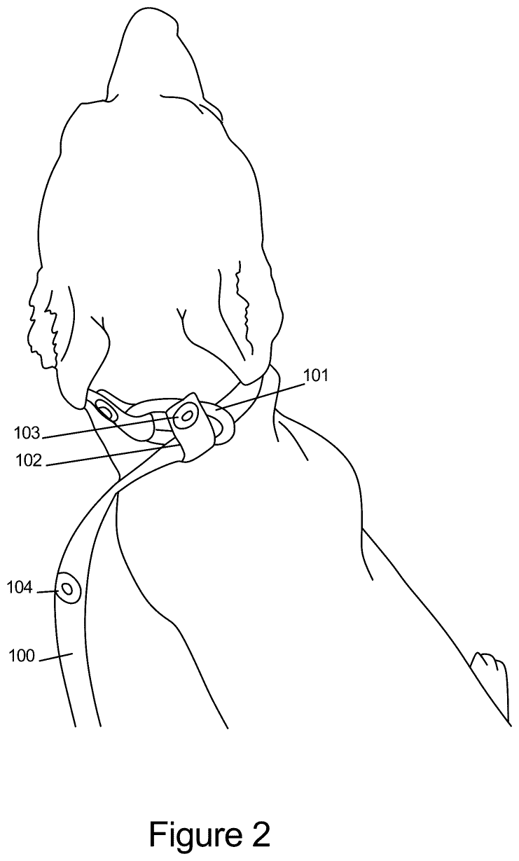

In the illustrated embodiment, the leash 100 is mechanically coupled to collar 200 via a gate clip 101, including without limitation a carabiner (shown), trigger snap, bolt snap, talon snaps, or any other means for detachably coupling the leash 100 to the collar 200. The gate clip 101 is secured to any conventional dog color, or the collar 200 shown having a safety O-ring 203, which is centrally positioned on collar 200 to facilitate balanced control. The gate clip 101 is configured to allow leash 100 to slide through easily, supporting a secondary slip-lead function when required, as discussed below in relation to FIG. 2.

Proximate to a first loop for the gate clip 101, the leash 100 features a guide-loop 105. The guide-loop 105 is a second loop (adjacent to the first loop) formed by a continuous segment of the leash material that can, in one embodiment, be detached from itself at its farthest end via a fastening feature, such as a snap 106. Alternatively, the guide-loop 105 may be fixed (non-detachable) with a rivet or other means for securing the leash material in a fixed relationship to itself, including without limitation welding, sewing, knots, weaving, adhesives, etc. This loop 105 is specifically configured to guide and secure the leash when the system is transitioned into a thorax-wrap configuration around the dog's chest, as shown and described below. Additionally, the guide-loop 105 and its associated snap 106 serve as an auxiliary attachment point for accessories, such as a waste bag dispenser.

While not explicitly shown in the current view of the assembly, the leash 100 further includes integrated slides 102, with or without grommets 103, 104, including cord locks (shown in FIG. 13) distributed along its length to allow the user to modify the effective length of the leash or to create various attachment points for hands-free operation (e.g., waist or shoulder carry). An appropriately sized cord lock may be used for slip lead and for harness configurations (on the dog side) as opposed to the human side.

FIG. 2 illustrates a top perspective view of the animal control system in a second configuration, specifically highlighting the interaction between the leash 100 and the collar 200. In this embodiment, the leash 100 is configured to provide specialized control through the use of integrated hardware and proprietary looping structures. As shown in FIG. 2, the leash 100 is configured for use in a second configuration with slip lead functionality at either end of leash 100 opposite the guide-loop 105. In this configuration, leash 100 is passed through the gate clip 101 to form a cinchable loop, preferably with slide 102 positioned to create a stop that prevents the loop around the dog's neck from opening. The gate clip 101 is designed to allow for quick attachment and detachment while providing a smooth internal surface that permits the leash material to slide through when the system is utilized in a slip-lead or harness-wrap orientation.

An important aspect of the leash 100 is the inclusion of at least one integrated slide 102. The integrated slide 102 is moveably disposed along the length of the leash 100 and preferably includes a grommet 103. This slide 102 allows the user to adjust the effective length of the leash or to create a fixed stop point for the loop around the dog's neck. In the embodiment with the cord lock, the slide with grommet may be for the human side and the cord lock for dog side adjustments. In the configuration shown, the slide 102 and grommet 103 are positioned proximate to the second gate clip 101 (opposite to the first gate clip 101 located at the end of leash 100 with the guide-loop 105), which may serve to limit the travel of the gate clip or to secure a specific loop diameter around the dog's anatomy.

The leash 100 may further include a plurality of integrated fixed grommets 104 positioned at intervals along the strap of the leash 100. These fixed grommets 104 provide reinforced attachment points for auxiliary items, such as waste bag dispensers, or serve as anchor points for the gate clip 101 when the leash is configured for different handling modes (e.g., waist-worn or shoulder-slung).

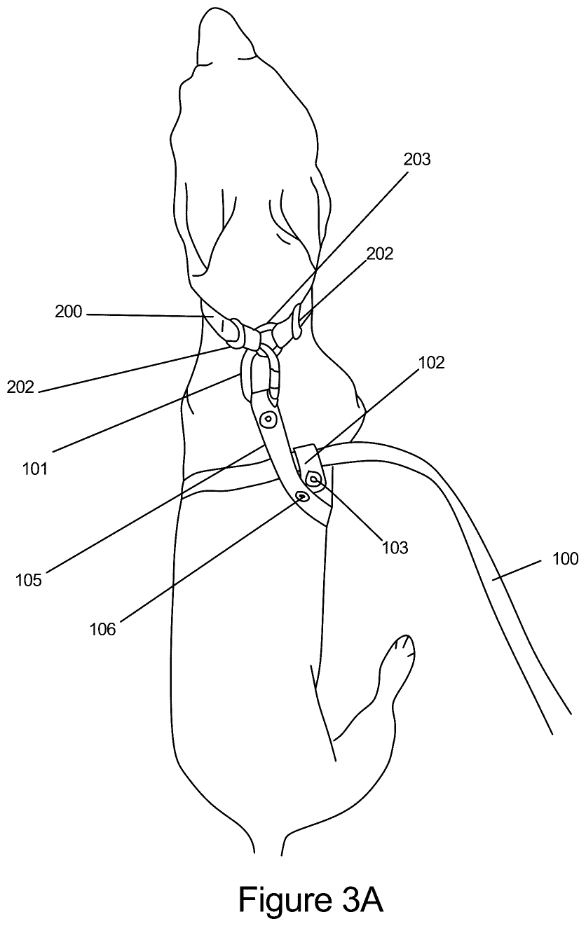

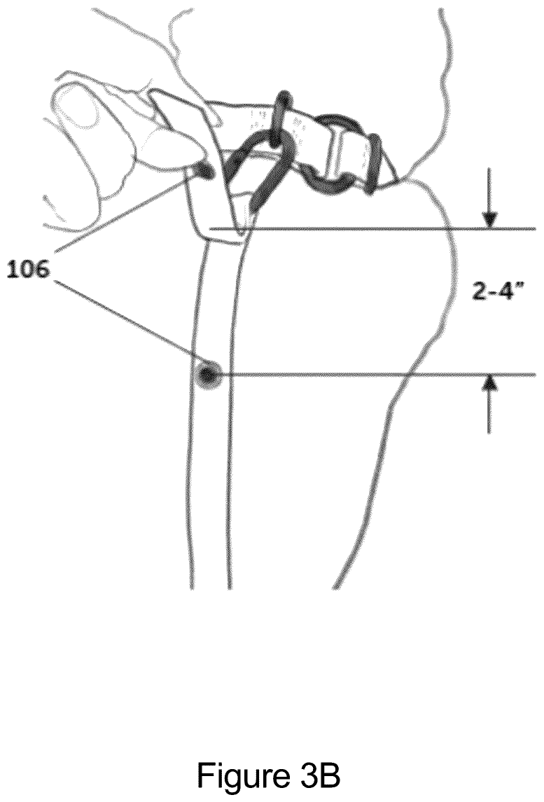

FIG. 3A illustrates a top perspective view of the animal control system in a third configuration as a chest (thorax) harness. In this configuration, the leash 100 is used with collar 200 to provide distributed control across the canine subject's body. As shown in this configuration, gate clip 101 is attached to the O-ring in collar 200. A portion of the leash 100 extends from gate clip 101 attached to collar 200 wraps around the thorax of the dog. The “guide-loop” 105 (as seen in FIG. 1) is utilized to guide and secure the leash in this wrapped position. The loop around the dog's thorax is secured via a slide 102 or similar fastening feature to maintain the harness structure. The integrated slide 102, such as the cord lock shown in FIG. 13, acts as a mechanical stop to regulate the tension and fit of the harness around the dog's chest. By adjusting the position of the slide 102 along the leash 100, the handler can customize the fit for dogs of varying sizes, ensuring the harness remains secure without causing discomfort.

This thorax-wrap configuration effectively discourages pulling by redirecting the dog's forward momentum without engaging the opposition reflex typically triggered by standard flat collars or front-only harnesses. The gate clip 101 facilitates the transition between the standard lead configuration and this harness mode by allowing the leash to slide through the guide-loop 105 easily to create the necessary loops.

FIG. 3B illustrates a detailed perspective view of the connection mechanism for the harness configuration, specifically demonstrating the operation of the leash 100 with guide-loop 105. In this view, a user's hand is shown manipulating the leash 100 to secure the thorax-wrap around the canine subject. The guide-loop 105 is generally formed by folding and securing a segment of the leash back upon itself. As depicted in this embodiment, the guide-loop 105 is opened to allow leash 100 to be routed through loop 105 and around the animal's chest and closed via snap 106 as shown in FIG. 3A to complete the harness configuration.

The snap 106 comprises a male component and a female component integrated into the leash strap. In a preferred embodiment, these components are spaced apart by a predetermined distance, for example, between 2 and 4 inches, to provide an appropriately sized aperture for guiding the trailing end of the leash 100. This specific spacing ensures that the loop remains secure under tension while allowing the leash to slide through for dynamic adjustment. Different spacing may be provided for dogs of different sizes. As discussed above, guide-loop 105 may be fixed, in which instance the user would pass the trailing end of leash 100 through the closed loop 105 for use as a harness.

The guide-loop 105 serves as a specialized guide that maintains the orientation of the thorax wrap, preventing the leash from shifting toward the animal's throat or forelegs during use. By engaging the snap 106, the handler creates a stable, yet adjustable, harness structure that provides tactile feedback to the dog without the permanence of a dedicated harness.

The combination of the gate clips 101, the adjustable slides 102, the guide-loop 105, and the fixed grommets 104 allows the animal control system to transition seamlessly between use with a standard neck-collar lead or the collar 200, a head halter, and a thorax-wrap harness without requiring the removal of the leash from the dog. This modularity/adaptability addresses the need for a unified system that adapts to various training and management scenarios.

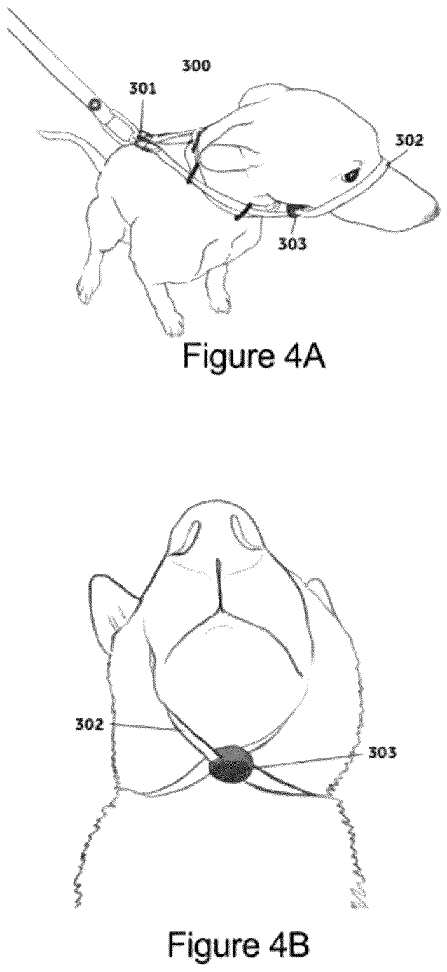

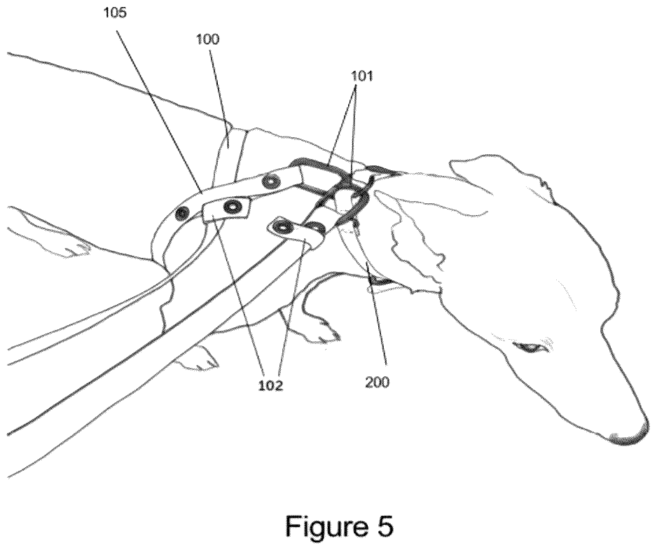

FIG. 4A illustrates a view of the animal control system in another configuration, specifically with an integral head halter 300 assembly. In this configuration, the collar 200 includes an additional pair of D-rings 202 distributed along the circumference of the collar 200 and remain in a fixed, equal-distant position relative to the safety O-ring 203. The head halter 300 is coupled to the collar 200 (as seen in previous figures) and the leash 100 to redirect the canine subject's head movement.

The head halter 300 includes a nose strap loop 302 configured to fit over the snout of the animal. The nose strap loop 302 is preferably constructed of a narrow flat strap material, such as Biothane or nylon. The positioning and security of the nose strap 302 are maintained by a proprietary “halter-cross” 303 component, shown in FIG. 4B. The halter-cross 303 is a guiding element that positions the nose strap segments at approximately 90 degrees to each other, allowing each segment to slide independently to ensure a custom, snug fit on the animal's face.

The head halter 300 further includes two small D-rings 301 positioned at the terminal ends of the halter straps. These D-rings 301 serve as the primary attachment points for the leash 100. As shown in FIG. 4B, the gate clip 101 of the leash 100 may be passed through both D-rings 301 simultaneously to provide a secure, balanced connection point behind the animal's head.

The halter straps are integrated with the collar 200 via symmetrically positioned D-rings 202 (as seen in FIG. 1), which ensure that the head halter remains correctly oriented relative to the animal's neck regardless of movements or leash tension. This multi-point connection system allows the handler to apply gentle pressure to the snout to guide the dog, which is more effective for redirection than pressure applied solely to the neck.

FIG. 4B illustrates an enlarged, bottom perspective view of the head halter 300 assembly, specifically detailing the mechanical orientation of the proprietary “halter-cross” 303 positioned under the canine subject's chin. This view highlights the functional interaction between the nose strap 302 and the guiding hardware that facilitates head-controlled management.

The nose strap 302 is configured to pass under the mandible of the animal, where it intersects at the halter-cross 303. The halter-cross 303 acts as a specialized junction member designed to position the segments of the nose strap 302 at approximately 90 degrees to each other. As shown in the illustration, the nose strap 302 enters and exits halter-cross 303, which serves as a friction-reducing guide.

In a preferred embodiment, the halter-cross 303 is constructed to allow the segments of the nose strap 302 to slide independently of each other. This independent sliding action ensures that the head halter 300 automatically adjusts to the contours of the dog's snout and jaw, providing a secure fit that remains stable during directional changes or when tension is applied via the leash.

The halter-cross 303 may be manufactured from various durable materials suitable for pet hardware, including but not limited to plastic or metal. By positioning this component directly under the chin, the system ensures that redirected force is distributed evenly across the snout, allowing for precise control and training feedback with minimal physical effort from the handler.

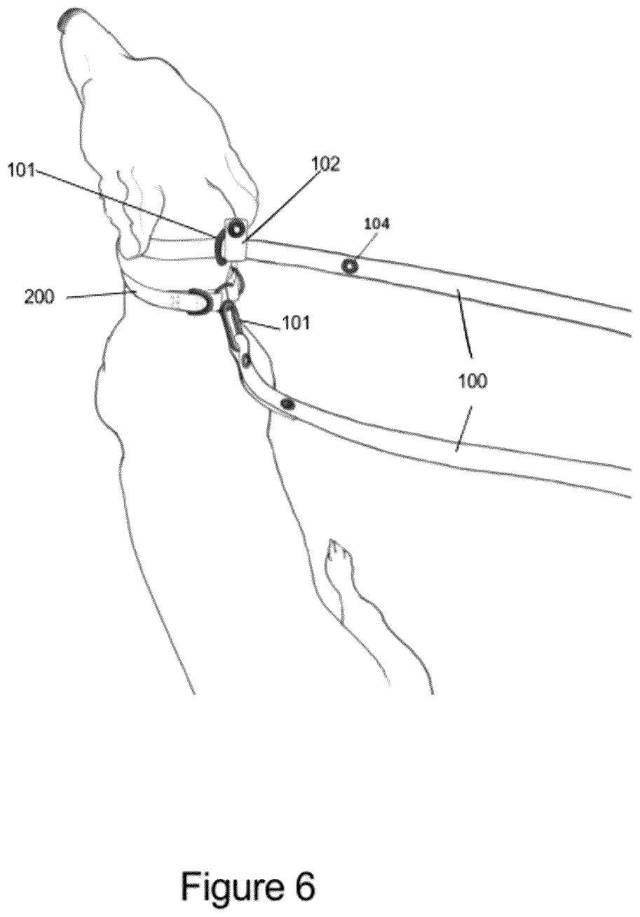

FIG. 5 illustrates a side perspective view of the animal control system configured as a thorax-wrap harness to discourage pulling behavior. In this configuration, the leash 100 is wrapped around the thorax of the dog and with the training end secured to the collar assembly to provide balanced physical feedback and reducing the length of the leash by half for better handler control.

The harness structure is maintained by the interaction of the leash 100 with the collar's safety O-ring 203 (as previously discussed) and the integrated slides 102. As shown, the leash 100 is routed under the dog's chest and back up toward the dorsal area, where it is anchored at the top of the collar. This attachment point may be used to provide minor feedback to the dog or to effectively shorten the operational length of the leash 100.

Two integrated slides 102, such as the slide 102 with grommet 103 and/or the cord lock, are utilized in this configuration to act as mechanical stops. These slides 102 are moveably disposed along the leash 100 to allow for custom fitment based on the dog's girth. By positioning the slides 102 against the hardware, the handler can ensure the thorax wrap remains secure and does not slip during use, thereby maintaining consistent pressure for behavioral reinforcement.

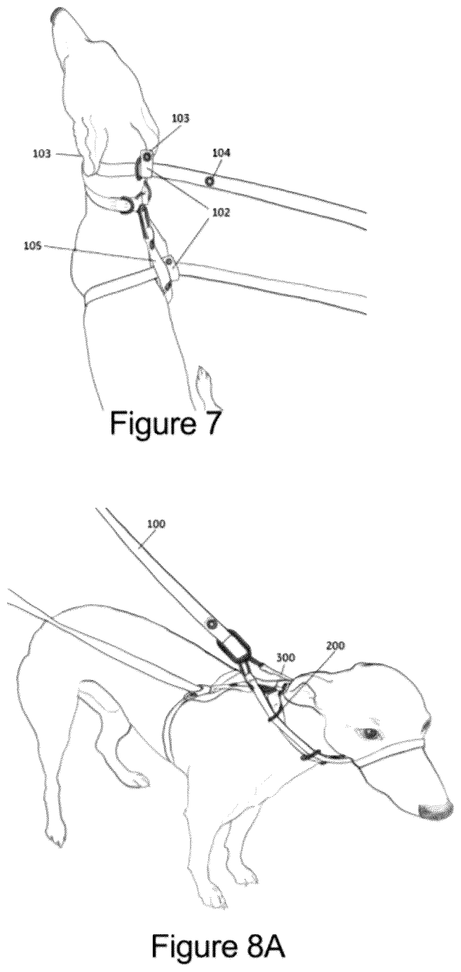

FIG. 6 illustrates a top perspective view of the animal control system in another configuration, utilizing an integrated slip lead functionality in combination with a standard collar attachment. This configuration provides dual points of contact on the canine subject for enhanced security and training redirection.

In this embodiment, a first portion of the leash 100 is routed to form a loop around the animal's neck, functioning as a slip lead. This loop is maintained and regulated by an integrated slide 102 with grommet 103 (as seen in FIG. 5) or with cord lock (as seen in FIG. 13) which acts as a limit for the loop diameter. The integrated fixed grommets 104 may be distributed along the leash 100 to provide optional fixed attachment points or to serve as tactile indicators for the handler. Simultaneously, a second portion of the leash 100 is coupled to the flat collar 200 via a gate clip 101 (as previously discussed). This dual-connection method ensures that if one attachment point were to fail or if the animal were to slip out of the primary collar, the integrated slip lead serves as a safety backup.

The gate clip 101 facilitates this setup by providing a secure connection to the collar's D-rings 202 or safety O-ring 203, while the length of the leash is managed to prevent tangling between the two connection points. This configuration is particularly useful for high-distraction environments where maximum control is required without the need for additional equipment.

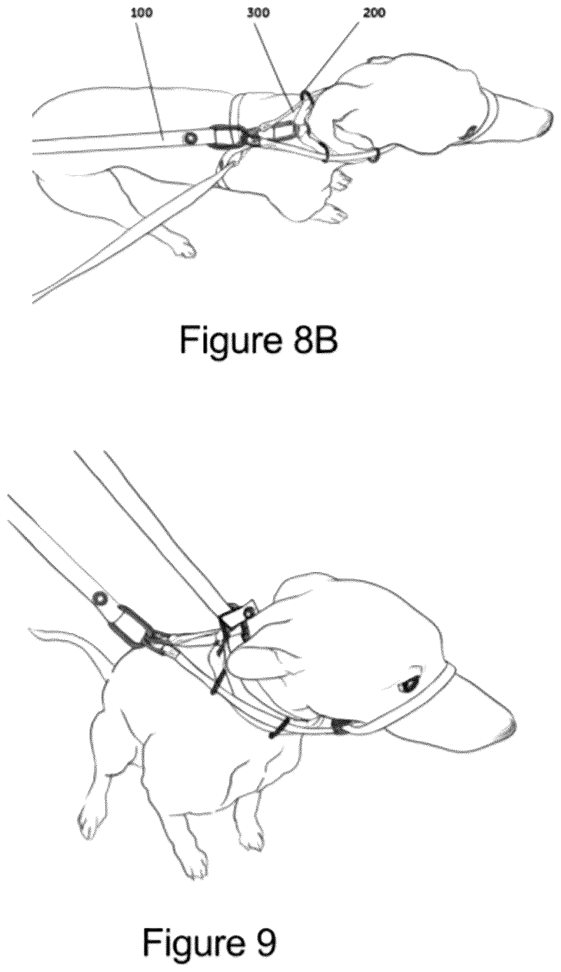

FIG. 7 illustrates a top perspective view of the animal control system, utilizing three distinct points of contact on the canine subject. In this embodiment, the leash 100 is routed to provide integrated slip lead functionality around the neck, which is regulated by a first slide 102 that acts as a mechanical stop. Simultaneously, the leash is coupled to the flat collar 200 via a gate clip 101 and further extends to wrap around the animal's thorax. The thorax wrap is guided and secured by guide-loop 105, as discussed above, ensuring the assembly remains stable while discouraging pulling behavior through distributed physical feedback.

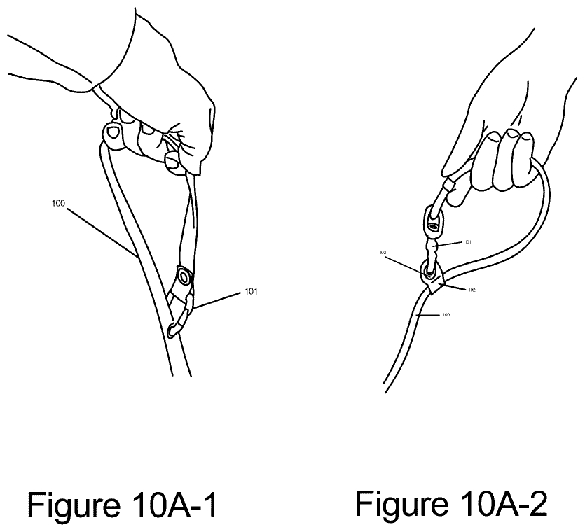

FIG. 8A and FIG. 8B illustrate side and perspective views, respectively, of the system configured for maximum directional control. In this configuration, leash 100 is attached to the flat collar 200 and wrapped around the dog's thorax as previously described. An additional attachment point is established with the removable head halter 300, as also discussed above. This assembly allows the handler to manage the dog's forward momentum through the thorax wrap while simultaneously providing precise directional guidance via the head halter, which redirects the dog's head movement without engaging the opposition reflex.

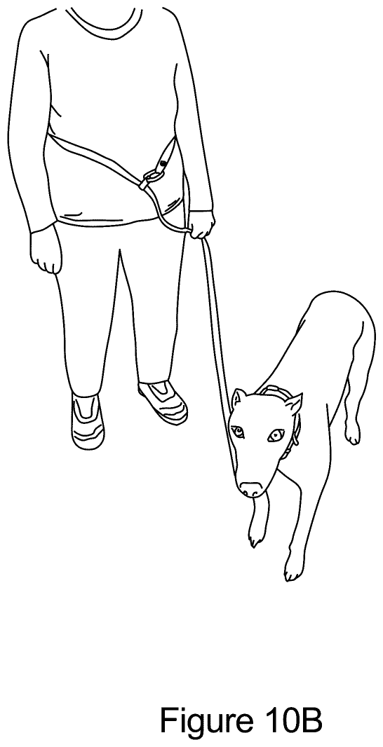

FIG. 9 illustrates a perspective view of the system utilizing dual-control neck and head configuration. The leash 100 in this configuration is attached to the dog's neck via the integrated slip lead functionality and is further coupled to the removable head halter 300 (without attachment to the collar O-ring). This configuration is designed for high-distraction environments where the handler requires the safety of a slip lead backup alongside the advanced redirection capabilities of the head halter.

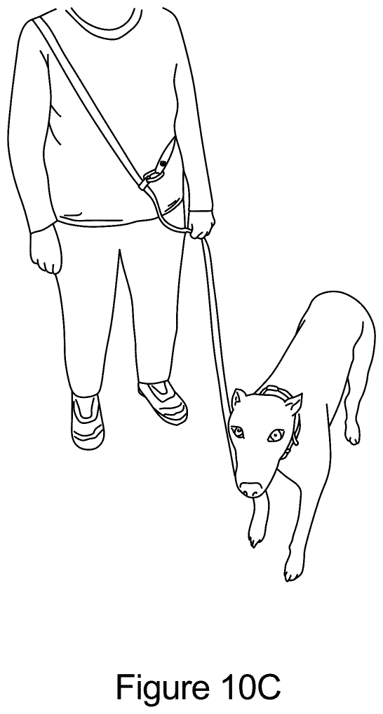

FIGS. 10A through 10D detail the versatile attachment points provided on the proximal end of the leash 100 for the handler or stationary objects. FIGS. 10A-1 and 10A-2 depicts trailing end of the leash configured as a wrist loop for standard manual control by attaching the trailing edge gate clip 101 to the trailing edge grommet 104. FIG. 10B and FIG. 10C illustrate the leash adjusted via the integrated slides 102 and grommets 103 therein to be worn as an adjustable waist loop or shoulder loop, respectively, for hands-free operation. FIG. 10D demonstrates the leash coupled to a stationary post or similar object, utilizing the gate clips 101 and grommets to create a secure tether.

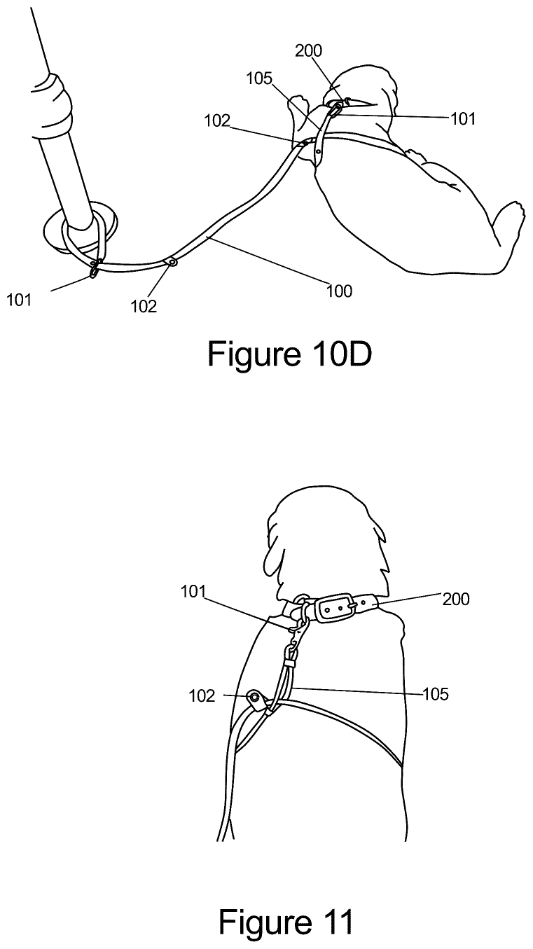

FIGS. 11 and 13 illustrate an alternative embodiment of the leash 100 featuring a round cross-section. As described in the specification, while the flat leash typically measures between 7/16″ and 1″ in width, the round leash embodiment comprises a thickness between 6 mm and 12 mm. The round leash maintains the same functional hardware as the flat version, including gate clips 101 and adjustable slides 102, except without fixed grommets 104, and may be constructed from materials such as Biothane, Nylon, or Leather. In one embodiment the animal control system includes at least one integrated slide moveably disposed along the elongated strap between the first end and the second end and a cord lock moveably disposed along the elongated strap between the first end and the first integrated slide.

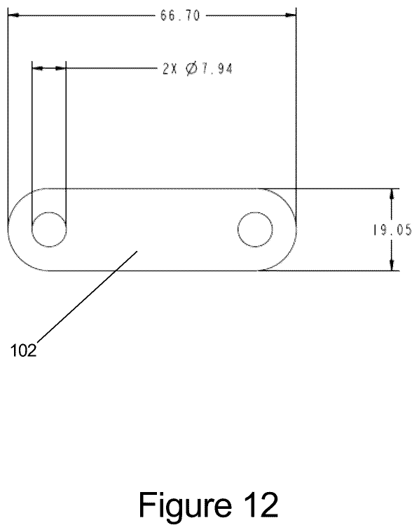

FIG. 12 illustrates a plan view of a preassembled slide 102, that is, a drawing of the die cut biothane prior to being folded and assembled using the grommet 103. As discussed, slider 102 is a modular component of the animal control system designed to be slidably disposed along the elongated strap 100 of the leash. As illustrated in the technical drawing, the slide 102 includes a generally rectangular body with rounded terminal ends. In a preferred embodiment, the slide body has a total longitudinal length of approximately 66.70 mm and a vertical width of approximately 19.05 mm.

The slide 102 features a plurality of apertures, specifically one circular grommet 103, symmetrically positioned proximate to each terminal end of the slide body. Each aperture has an internal diameter of approximately 7.94 mm. The slide 102 is folded over to accept grommet 103, which is configured to receive hardware such as the gate clips 101, enabling the creation of custom leash lengths or fixed attachment points for various handling configurations, including wrist, shoulder, or waist loops.

While the foregoing invention has been described in some detail for purposes of clarity and understanding, it will be appreciated by one skilled in the art, from a reading of the disclosure, that various changes in form and detail can be made without departing from the true scope of the invention.

What is claimed is

1. An animal control system comprising:
an elongated strap having a first end and a second end;
a first gate clip coupled to the first end of the elongated strap and a second gate clip coupled to the second end; and
a selectively engageable guide loop positioned proximate to the first end of the elongated strap, the guide loop comprising a segment of the elongated strap folded upon itself and secured by a first fastener and a second fastener, wherein the first fastener creates a first loop for attaching the first gate clip to the first end and the second fastener creates the guide loop adjacent to the first loop, the leash therewith configured for use selectively as at least a slip leash and a harness.

2. The animal control system of claim 1, wherein the second fastener comprises a snap assembly including a male component and a female component integrated into the elongated strap detachable from each other to provide an opening for routing the second end of the leash through the guide loop.

3. The animal control system of claim 1, wherein the first and second fasteners are spaced apart by a distance of about 2 to about 4 inches.

4. The animal control system of claim 1, further comprising at least one integrated slide moveably disposed along the elongated strap between the first end and the second end, the at least one integrated slide including a grommet configured to receive one of the first or second gate clips.

5. The animal control lead of claim 4, further comprising at least a second integrated slide moveably disposed along the elongated strap between the first end and the second end, wherein the second integrated slide comprises a cord lock configured to act as a mechanical stop to regulate the diameter of a loop formed by the elongated strap when the lead is configured as a slip lead or a thorax-wrap harness.

6. The animal control lead of claim 1, wherein the elongated strap comprises a material selected from the group consisting of Biothane, nylon, polypropylene, and leather.

7. The animal control lead of claim 1, in combination with a collar, the collar comprising:
a strap body and a buckle for securing the collar around an animal's neck;
a safety O-ring configured for attachment to at least the first gate clip; and
a first pair of symmetrically positioned D-rings maintained in a fixed position relative to the safety O-ring.

8. The animal control lead of claim 1, wherein the collar further comprises a second pair of symmetrically positioned rings maintained in a fixed position relative to the safety O-ring.

9. The animal control lead of claim 8, further comprising a removable head halter assembly, the head halter assembly including:
a nose strap portion;
a pair of rings configured to couple the nose strap to the first connector of the lead; and
a cross-junction member configured to position segments of the nose strap at approximately 90 degrees to each other while allowing each segment to slide independently through the cross-junction member; the collar further configured for the head halter assembly to attach to the first and second pairs of symmetrically spaced rings.

10. An animal control method comprising selectively configuring an animal control system between a slip leash and a harness function, the system comprising:
an elongated strap having a first end and a second end;
a first gate clip coupled to the first end of the elongated strap and a second gate clip coupled to the second end; and
a selectively engageable guide loop positioned proximate to the first end of the elongated strap, the guide loop comprising a segment of the elongated strap folded upon itself and secured by a first fastener and a second fastener, wherein the first fastener creates a first loop for attaching the first gate clip to the first end and the second fastener creates the guide loop adjacent to the first loop.

11. The animal control method of claim 10, wherein the second fastener comprises a snap assembly including a male component and a female component integrated into the elongated strap detachable from each other to provide an opening for routing the second end of the leash through the guide loop.

12. The animal control method of claim 10, wherein the first and second fasteners are spaced apart by a distance of approximately 2 to 4 inches.

13. The animal control method of claim 10, further comprising at least one integrated slide moveably disposed along the elongated strap between the first end and the second end, the at least one integrated slide including a grommet configured to receive one of the first or second gate clips.

14. The animal control method of claim 13, further comprising at least a second integrated slide moveably disposed along the elongated strap between the first end and the second end, wherein the second integrated slide comprises a cord lock configured to act as a mechanical stop to regulate the diameter of a loop formed by the elongated strap when the lead is configured as a slip lead or a thorax-wrap harness.

15. The animal control method of claim 10, wherein the elongated strap comprises a material selected from the group consisting of Biothane, nylon, polypropylene, and leather.

16. The animal control method of claim 10, the system in combination with a collar, the collar comprising:
a strap body and a buckle for securing the collar around an animal's neck;
a safety O-ring configured for attachment to at least the first gate clip; and
a first pair of symmetrically positioned D-rings maintained in a fixed position relative to the safety O-ring.

17. The animal control method of claim 10, wherein the collar further comprises a second pair of symmetrically positioned rings maintained in a fixed position relative to the safety O-ring.

18. The animal control method of claim 17, further system comprising a removable head halter assembly, the head halter assembly including:
a nose strap portion;
a pair of rings configured to couple the nose strap to the first connector of the lead; and
a cross-junction member configured to position segments of the nose strap at approximately 90 degrees to each other while allowing each segment to slide independently through the cross-junction member; the collar further configured for the head halter assembly to attach to the first and second pairs of symmetrically spaced rings.

19. An animal control system comprising: an elongated strap having a first end and a second end, the first end configured to selectively attach to an animal in a plurality of ways and the second end configured to selectively attach to the handler in another plurality of ways.

20. The animal control system of claim 19, wherein the elongated strap comprises a first gate clip coupled to the first end of the elongated strap and the second a second gate clip coupled to the second end; and a selectively engageable guide loop positioned proximate to the first end of the elongated strap, the guide loop comprising a segment of the elongated strap folded upon itself and secured by a first fastener and a second fastener, wherein the first fastener creates a first loop for attaching the first gate clip to the first end and the second fastener creates the guide loop adjacent to the first loop, the leash therewith configured for use selectively as at least a slip leash and a harness.
